(19) United States
(12) Patent Application Publication
(10) Pub. No.: US 2019/0122059 A1
(43) Pub. Date: Apr. 25, 2019

(54) SIGNAL LIGHT DETECTION

(71) Applicant: AGENCY FOR SCIENCE, TECHNOLOGY AND RESEARCH, Singapore (SG)

(72) Inventors: Lubing ZHOU, Singapore (SG); Jiangang WANG, Singapore (SG); Serin LEE, Singapore (SG); Yu PAN, Singapore (SG); Zhiwei SONG, Singapore (SG)

(21) Appl. No.: 16/089,365

(22) PCT Filed: Mar. 31, 2017
(86) PCT No.: PCT/SG2017/050188

§ 371 Date: Sep. 27, 2018

(30) Foreign Application Priority Data
Mar. 31, 2016 (SG) 10201602565Y

(51) Int. Cl. G06K 9/00; G06K 9/46; G06K 9/62; G06T 7/20; G06T 7/73

(52) U.S. Cl. CPC G06K 9/00825; G06K 9/4676; G06K 9/4647; G06K 9/4652; G06T 2207/30241; G06T 7/20; G06K 9/6228; G06T 7/73; G06K 9/628

(57) ABSTRACT

There is provided a method of signal light detection, and a corresponding signal light detection device. The method includes obtaining a dark frame of an environment, the dark frame comprising a plurality of light blobs captured corresponding to lights captured in the environment, obtaining a bright frame of the environment, the bright frame comprising a plurality of light blobs corresponding to lights captured in the environment, identifying a plurality of candidate light blobs from the plurality of light blobs in the dark frame, identifying a plurality of candidate regions in the bright frame based on the plurality of candidate light blobs identified from the dark frame, classifying each of the plurality of candidate light blobs based on the corresponding candidate region from the bright frame, and evaluating whether one or more of the plurality of classified candidate light blobs is a signal light from a particular type of signaling device.

### CROSS-REFERENCE TO RELATED APPLICATION

This application claims the benefit of priority of Singapore Patent Application No. 10201602565Y, filed 31 Mar. 2016, the contents of which being hereby incorporated by reference in its entirety for all purposes.

### TECHNICAL FIELD

The present invention generally relates to signal light detection, including a method of signal light detection and a signal light detection device, such as but not limited to traffic light detection.

### BACKGROUND

Robust signal light detection is important for various applications, such as traffic light detection, brake light detection, and indicator light detection for autonomous vehicles. For example, varying illumination conditions and analogical false alarms are two key challenges in real-world scenarios.

In the case of traffic light for example, when human perceives traffic lights, various cues are utilized to make a final decision on the status of the traffic light, including undistorted colour, casing shape, context texture, and even three-dimensional (3D) geometrical information. While human vision readily adapts to changing lighting conditions, camera sensors often have to reach a compromise between unpolluted colours and rich surrounding context, especially under dark lighting conditions due to the limited dynamic range. For traffic light application, most conventional methods use frames from one single constant camera setting (shutter and gain) or adaptive setting according to changing lighting conditions. However, single-channel frames inevitably lead to a dilemma of whether to configure setting to obtain better colours but with the trade-off of little context texture, or to configure setting to obtain rich context information but with the trade-off of large colour tone shifting and halo disturbances.

In object detection, an emphasis may be on advanced and complex computer vision algorithms that may have better robustness under harsh lighting conditions. However, from another viewpoint, a more elegant use of the camera can save computational cost. In practice, imager optimizes the exposure values by setting the shutter and gain to have proper lighting responses on captured scene. The ideal result is that all the objects in the scene have little or no colour tone shifting and rich texture in the context. This is however difficult to achieve in conventional camera engineering. Referring to autonomous vehicles as an example, the lighting conditions change greatly when the vehicle navigates through different environments. As a result, it is difficult to determine an optimal exposure values with unusual or inconsistent lighting distributions. Often a few settings could be manually set for different environmental conditions, such as weather conditions. More advanced camera capturing methods commonly apply adaptive shutter and gain settings according to certain statistical measurements to obtain the frames. Although such techniques may be useful and could relieve the problem to a certain degree, the problem persists in many scenarios. For example, to detect objects such as traffic lights, traffic signs, vehicles and pedestrians with a single camera, it is difficult to achieve optimal detection of all four objects, especially in dark lighting scenarios. For example, traffic lights and traffic signs require relatively lower exposure values to prevent over-exposure due to artificial light or reflection property, while vehicles and pedestrians would require higher exposure to extract rich texture information.

The dilemma of exposure setting also occurs in single object detection, such as traffic light as an example. FIG. 1 depicts a schematic block diagram of a conventional traffic light recognition device 100. In the conventional traffic light recognition device 100, the unique colours and round shape of lights from the traffic light are considered as useful cues for quick detection of the potential lights, and followed by an appearance-based classification phase (i.e., HOG (histogram of oriented gradients) and SVM (support vector machine)) to remove false positives. During dark daytime or night time, the exposure level (i.e., shutter/gain) requires to be set low to prevent colour tone shifting and halo disturbances caused by over-exposure. In this manner, the detection part may be able to retrieve reliable colour and shape information to achieve satisfactory performance. However, as a trade-off, ambient passive-lighting objects, such as traffic light casing, trees and vehicles, become so dim that it is difficult for appearance-based methods to perform recognition with sufficient accuracy.

A need therefore exists to provide a method of signal light detection and a signal light detection device that seek to overcome, or at least ameliorate, one or more of the deficiencies of conventional signal light detection, such as traffic light detection. It is against this background that the present invention has been developed.

### SUMMARY

According to a first aspect of the present invention, there is provided a method of signal light detection, comprising:

obtaining a dark frame of an environment, the dark frame comprising a plurality of light blobs corresponding to lights captured in the environment;

obtaining a bright frame of the environment, the bright frame comprising a plurality of light blobs corresponding to lights captured in the environment;

identifying a plurality of candidate light blobs from the plurality of light blobs in the dark frame;

identifying a plurality of candidate regions in the bright frame based on the plurality of candidate light blobs identified from the dark frame;

classifying each of the plurality of candidate light blobs based on the corresponding candidate region from the bright frame; and

evaluating whether one or more of the plurality of classified candidate light blobs is a signal light from a particular type of signaling device.

In various embodiments, the signal light to be detected has a first predetermined property, and wherein identifying a plurality of candidate light blobs comprises:

generating a saliency map based on the dark frame with respect to the first predetermined property; and

for each pixel of the saliency map that has a saliency score above a predetermined threshold, labeling the pixel with a property label related to the first predetermined property.

In various embodiments, the saliency score is an overall saliency score determined for each of a plurality of pixels of the dark frame with respect to a plurality of predetermined types of the first predetermined property,

said identifying a plurality of candidate light blobs further comprises determining, for each pixel of the saliency map that has an overall saliency score above the predetermined threshold, individual saliency scores for the pixel with respect to the plurality of predetermined types of the first predetermined property, respectively, and

said labeling the pixel comprises labeling the pixel with a property label corresponding to one of the plurality of predetermined types of the first predetermined property.

In various embodiments, the overall saliency score is determined based on a plurality of histograms related to the plurality of predetermined types of the first predetermined property, respectively.

In various embodiments, the first predetermined property is a colour of the signal light and the plurality of predetermined types is a plurality of predetermined types of colour.

In various embodiments, identifying a plurality of candidate light blobs further comprises:

applying a predetermined threshold to the saliency map to obtain a saliency mask;

identifying a plurality of groups of neighbouring pixels in the saliency mask as the plurality of candidate light blobs, respectively, each group of neighbouring pixels having common property labels; and

wherein the signal light to be detected has a second predetermined property, and for each of the plurality of candidate light blobs, determining whether to discard the candidate light blob from the plurality of candidate light blobs based on a second property of the candidate light blob in saliency mask with respect to the second predetermined property.

In various embodiments, identifying a plurality of candidate regions comprises:

for each of the plurality of candidate light blobs, locating a corresponding light blob in the bright frame based on a position of the candidate light blob from the dark frame, and identifying a corresponding candidate region in the bright frame based on a position of the located corresponding light blob in the bright frame.

In various embodiments, each of the plurality of candidate light blobs is classified using a classifier trained with respect to a plurality of predetermined types of classes, and classifying each of the plurality of candidate light blobs comprises:

processing the candidate region corresponding to the candidate light blob to classify the candidate region under one of the plurality of predetermined types of classes; and

labeling the candidate light blob with a class label corresponding to the one of the plurality of predetermined types of classes which the corresponding candidate region is classified under,

wherein whether one or more of the plurality of classified candidate light blobs is a signal light from the particular type of signaling device is evaluated based on the respective class labels associated with the one or more classified candidate light blobs.

In various embodiments, the method further comprises:

tracking at least one of the classified candidate light blobs evaluated to be said signal light for a series of bright frames to obtain a trajectory associated with the classified candidate light blob; and

verifying whether the at least one of the classified candidate light blobs evaluated to be the signal light is said signal light based on one or more characteristics of the trajectory associated thereto.

In various embodiments, the particular type of signaling device is a traffic light, and the plurality of predetermined types of colours comprises green, amber, and red.

According to a second aspect of the present invention, there is provided a signal light detection device, comprising:

a frame module configured to obtain a dark frame and a bright frame of an environment, the dark frame and the bright frame each comprising a plurality of light blobs corresponding to lights captured in the environment;

a candidate light blob identification module configured to identify a plurality of candidate light blobs from the plurality of light blobs in the dark frame;

a candidate region identification module configured to identify a plurality of candidate regions in the bright frame based on the plurality of candidate light blobs identified from the dark frame;

a classifier module configured to classify each of the plurality of candidate light blobs based on the corresponding candidate region from the bright frame; and

a signal light evaluation module configured to evaluate whether one or more of the plurality of classified candidate light blobs is a signal light from a particular type of signaling device.

In various embodiments, the signal light to be detected has a first predetermined property, and wherein the candidate light blob identification module is further configured to:

generate a saliency map based on the dark frame with respect to the first predetermined property; and

for each pixel of the saliency map that has a saliency score above a predetermined threshold, label the pixel with a property label related to the first predetermined property.

In various embodiments, the saliency score is an overall saliency score determined for each of a plurality of pixels of the dark frame with respect to a plurality of predetermined types of the first predetermined property, and

the candidate light blob identification module is further configured to:
determine, for each pixel of the saliency map that has an overall saliency score above the predetermined threshold, individual saliency scores for the pixel with respect to the plurality of predetermined types of the first predetermined property, respectively, and
label the pixel with a property label corresponding to one of the plurality of predetermined types of the first predetermined property.

In various embodiments, the overall saliency score is determined based on a plurality of histograms related to the plurality of predetermined types of the first predetermined property, respectively.

In various embodiments, the candidate light blob identification module is further configured to:

apply a predetermined threshold to the saliency map to obtain a saliency mask;

identify a plurality of groups of neighbouring pixels in the saliency mask as the plurality of candidate light blobs, respectively, each group of neighbouring pixels having common property labels; and

wherein the signal light to be detected has a second predetermined property, and for each of the plurality of candidate light blobs, determine whether to discard the candidate light blob from the plurality of candidate light blobs based on a second property of the candidate light blob in the saliency mask with respect to the second predetermined property.

In various embodiments, the candidate region identification module is further configured to:

for each of the plurality of candidate light blobs, locate a corresponding light blob in the bright frame based on a position of the candidate light blob from the dark frame, and identify a corresponding candidate region in the bright frame based on a position of the located corresponding light blob in the bright frame.

In various embodiments, the classifier module is trained with respect to a plurality of predetermined types of classes, and the classifier module is further configured to:

process the candidate region corresponding to the candidate light blob to classify the candidate region under one of the plurality of predetermined types of classes; and

label the candidate light blob with a class label corresponding to the one of the plurality of predetermined types of classes which the corresponding candidate region is classified under,

wherein the signal light evaluation module is configured to evaluate whether one or more of the plurality of classified candidate light blobs is a signal light from the particular type of signaling device based on the respective class labels associated with the one or more classified candidate light blobs.

In various embodiments, the signal light detection device further comprises a tracking module configured to:

track at least one of the classified candidate light blobs evaluated to be said signal light for a series of bright frames to obtain a trajectory associated to the classified candidate light blob; and

verify whether the at least one of the classified candidate light blobs evaluated to be the signal light is said signal light based on one or more characteristics of the trajectory associated thereto.

In various embodiments, the first predetermined property is a colour of the signal light, the particular type of signaling device is a traffic light, and the plurality of predetermined types of colour comprises green, amber, and red.

According to a third aspect of the present invention, there is provided a computer program product, embodied in one or more computer-readable storage mediums, comprising instructions executable by one or more computer processors to perform a method of signal light detection, the method comprising:

obtaining a dark frame of an environment, the dark frame comprising a plurality of light blobs corresponding to lights captured in the environment;

obtaining a bright frame of the environment, the bright frame comprising a plurality of light blobs corresponding to lights captured in the environment;

identifying a plurality of candidate light blobs from the plurality of light blobs in the dark frame;

identifying a plurality of candidate regions in the bright frame based on the plurality of candidate light blobs identified from the dark frame;

classifying each of the plurality of candidate light blobs based on the corresponding candidate region from the bright frame; and

evaluating whether one or more of the plurality of classified candidate light blobs is a signal light from a particular type of signaling device.

### BRIEF DESCRIPTION OF THE DRAWINGS

Embodiments of the present invention will be better understood and readily apparent to one of ordinary skill in the art from the following written description, by way of example only, and in conjunction with the drawings, in which:

FIG. 1 depicts a schematic block diagram of a conventional signal light detection technique;

FIG. 2 depicts a flow diagram of a method of signal light detection according to various embodiments of the present invention;

FIGS. 3A and 3B depict schematic drawings of signal light detection devices according to various embodiments of the present invention;

FIG. 4 depicts a schematic block flow diagram of an exemplary method of traffic signal light detection according to various example embodiments of the present invention;

FIGS. 5A to 5H depict example prior detection masks obtained for various detection ranges according to various example embodiments of the present invention;

FIGS. 6A and 6B depict example raw bright and dark frames obtained, respectively, according to various example embodiments of the present invention; and

FIGS. 6C and 6D depict example saliency map and saliency mask (binarized saliency map) obtained, respectively, from the dark frame shown in FIG. 6B.

### DETAILED DESCRIPTION

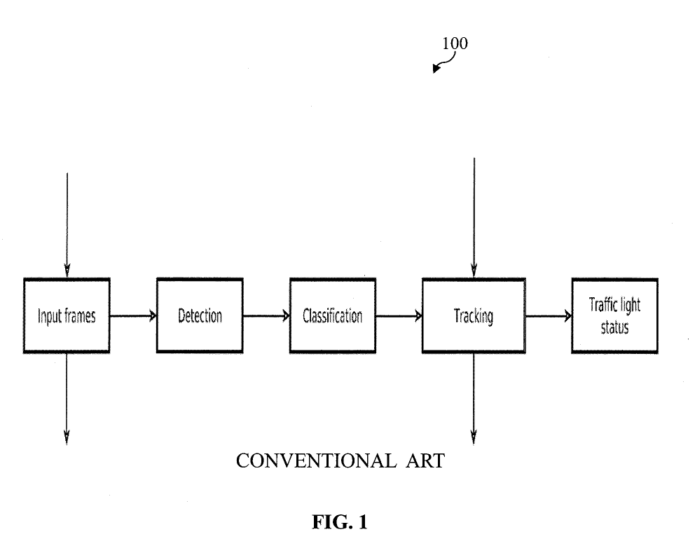

Embodiments of the present invention provide a method of signal light detection and a signal light detection device that seek to overcome, or at least ameliorate, one or more of the deficiencies of conventional signal light detection, such as, but not limited to, traffic light detection, vehicle brake light, vehicle indicator light detection, and so on. For example, as discussed in the background, conventional signal light detection devices, such as based on a conventional technique shown in FIG. 1, capture frames of an environment for signal light detection using a single channel that is configured (through camera settings) to achieve a desired balance between obtaining better colours (e.g., with respect to colour tone shifting and/or halo disturbances) but with the trade-off of inferior detail level (e.g., with respect to texture or context information) or better detail level but with the trade-off of inferior colours. Such a trade-off would inevitably lead to a dilemma on the particular settings to adopt and inevitably lead to a compromise in both the qualities of the colours and the details of the environment being captured to some degree, thus affecting the detection accuracy/relaibility of the conventional signal light detection device. Embodiments of the present invention advantageously avoid or address such a dilemma and the associated problems in conventional signal light detection devices.

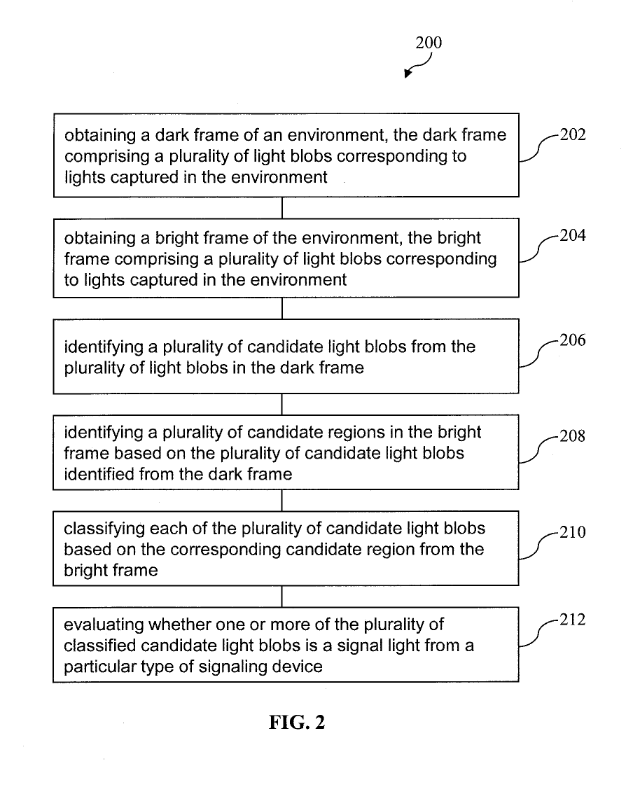

FIG. 2 depicts a flow diagram of a method 200 of signal light detection according to various embodiments of the present invention. The method 200 comprises a step 202 of obtaining a dark frame of an environment, the dark frame comprising a plurality of light blobs corresponding to lights captured in the environment, a step 204 of obtaining a bright frame of the environment, the bright frame comprising a plurality of light blobs corresponding to lights captured in the environment, a step 206 of identifying a plurality of candidate light blobs from the plurality of light blobs in the dark frame, a step 208 of identifying a plurality of candidate regions in the bright frame based on the plurality of candidate light blobs identified from the dark frame, a step 210 of classifying each of the plurality of candidate light blobs based on the corresponding candidate region from the bright frame, and a step 212 of evaluating whether one or more of the plurality of classified candidate light blobs is a signal light from a particular type of signaling device.

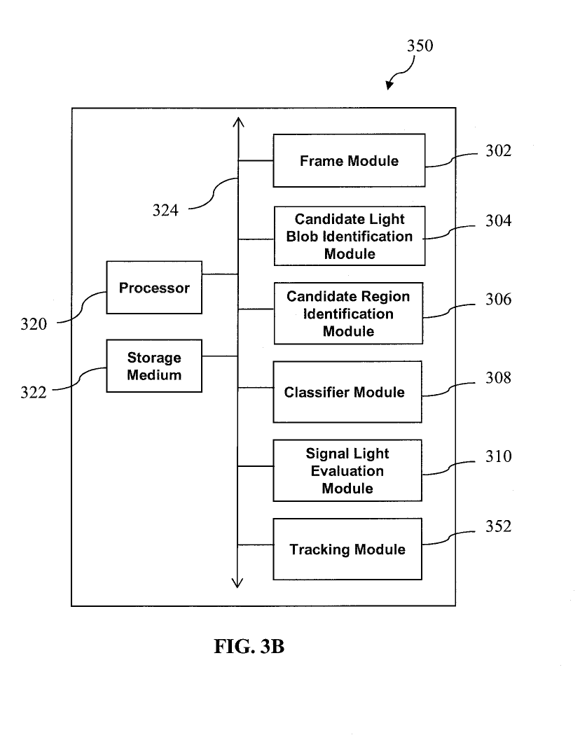

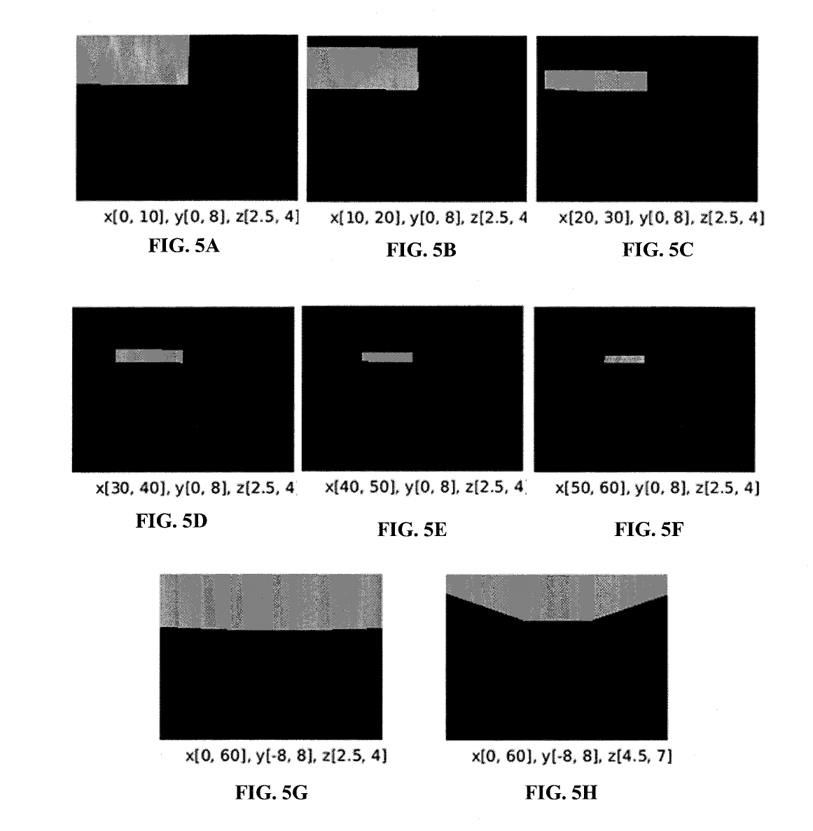

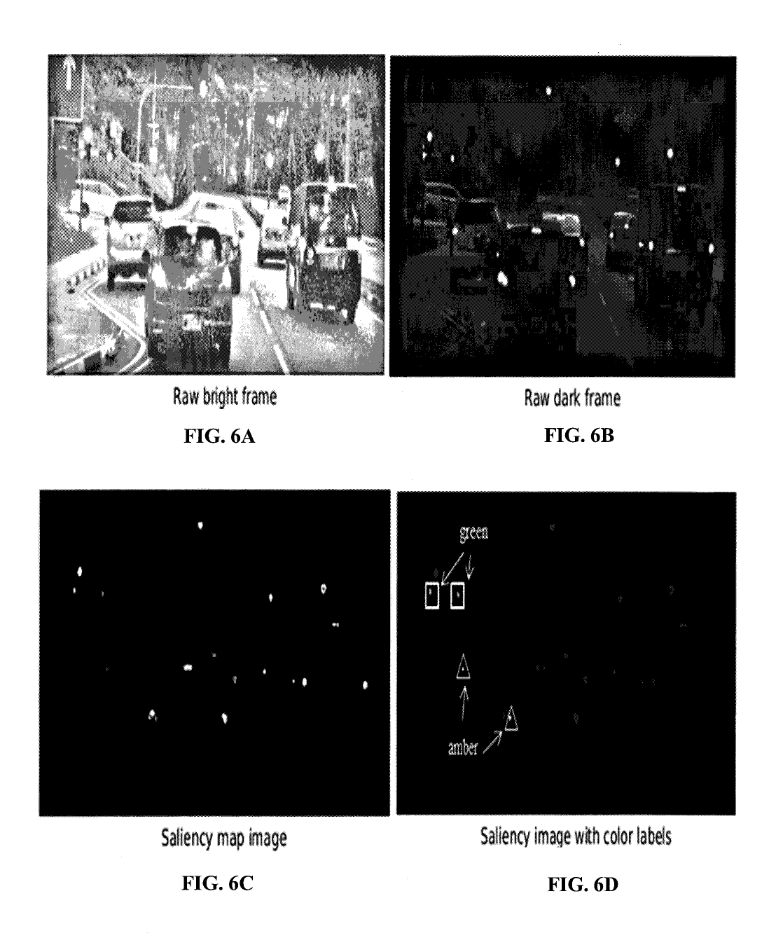

Accordingly, signal light detection according to various embodiments of the present invention advantageously adopts a multi-channel (e.g., dual-channel) detection technique or framework, including a dark channel and a bright channel for obtaining respective dark and bright frames of an environment in which the signal light detection is performed. In the context of various embodiments, a dark channel may correspond to setting(s) (e.g., configuring shutter and/or gain to achieve low exposure level) of an image capturing device (e.g., a still camera or a video camera) such that non-luminous object(s) in an environment captured in the frame are substantially or sufficiently dimmed (which may thus be referred to as a “dark frame”). On the other hand, a bright channel may correspond to setting(s) (e.g., configuring shutter and/or gain to achieve high exposure level) of an image capturing device such that non-luminous object(s) in an environment captured in the frame are sufficiently bright such that it is clearly visible in the frame (which may thus be referred to as a “bright frame”). By way of an example only and without limitation, FIGS. 4 and 6 to be described later below show examples of dark and bright frames.

With the multi-channel detection technique according to various embodiments of the present invention, for example, both the qualities of the colours and the details of the environment being captured may advantageously be optimized in separate channels without suffering the above-mentioned trade-off associated with conventional signal light detection devices, thus enhancing the detection accuracy or capability of the signal light detection device according to various embodiments of the present invention. In this regard, as described above, candidate light blobs are identified from the plurality of light blobs in the dark frame, whereas candidate light blobs are classified based on corresponding candidate regions, respectively, from the bright frame. Based on such an approach, candidate light blobs may advantageously be robustly detected based on the dark frame (e.g., with clearer/better or optimized quality of the light blobs captured) and advantageously be accurately classified based on the bright frame (e.g., with clearer/better or optimized quality of surrounding details captured). In other words, for detecting a signal light from a particular type of signaling device (e.g., traffic light) in an environment, the multi-channel detection technique may advantageously enable undistorted colour and shape information in dark frames, as well as rich context/texture information in the bright frames, to be utilized, thus addressing or overcoming the above-mentioned trade-off associated with conventional signal light detection devices.

In various embodiments, the signal light to be detected has a first predetermined property (e.g., colour), and identifying a plurality of candidate light blobs comprises generating a saliency map based on the dark frame with respect to the first predetermined property, and for each pixel of the saliency map that has a saliency score above a predetermined threshold, labeling the pixel with a property label related to the first predetermined property. In further embodiments, the saliency score is an overall saliency score determined for each of a plurality of pixels (e.g., all pixels) of the dark frame with respect to a plurality of predetermined types of the first predetermined property (e.g., predetermined types of colour, such as but not limited to, green, amber and red in the case of a traffic light). In this regard, identifying a plurality of candidate light blobs further comprises determining, for each pixel of the saliency map that has an overall saliency score above the predetermined threshold, separate/individual saliency scores for the pixel with respect to the plurality of predetermined types of the first predetermined property, respectively, and labeling the pixel described above comprises labeling the pixel with a property label corresponding to one of the plurality of predetermined types of the first predetermined property.

Accordingly, based on the dark frame, a saliency map is generated for making pixels which may belong to a candidate light blob more prominent to facilitate the identification of candidate light blobs from the light blobs in the dark frame. Furthermore, in the case of multiple predetermined types (i.e., multiple types of colour) of the first predetermined property associated with the signal light are being detected, an overall saliency score is advantageously determined for each pixel of the dark frame with respect to the multiple predetermined types collectively for significantly enhancing computational/processing efficiency, as such an approach avoids having to determine separate saliency scores with respect to the multiple predetermined types, respectively (that is, an individual saliency score for each predetermined type), for each pixel of the dark frame, which would result in three separate/individual saliency maps (one for each predetermined type) being generated. In contrast, as described above according to various embodiments of the present invention, an overall saliency score is determined for each pixel of the dark frame with respect to the multiple predetermined types collectively, and only if the overall saliency score for a pixel is above a predetermined threshold, individual saliency scores for such a pixel with respect to the multiple predetermined types, respectively, are determined.

In various embodiments, such individual saliency scores may then be compared and the pixel may then be considered as or labelled with a property label corresponding to the predetermined type that has achieved the highest saliency score amongst the individual saliency scores. For example, in the case of a traffic light, a pixel may be labelled with a red label if the red saliency score determined for the pixel is achieved the highest score amongst the individual red, green, and amber saliency scores determined for the pixel. With such an approach, a majority of the pixels may be filtered out by the overall saliency score, and individual saliency scores may only be required to be determined for the remaining pixels (above the predetermined threshold), for determining which predetermined type each of such remaining pixels belongs to and labelled accordingly. Accordingly, an overall saliency map is advantageously generated with information on the multiple predetermined types (e.g., pixels labelled with the respective predetermined type) from which candidate light blobs of respective predetermined type may be identified.

In various embodiments, the overall saliency score is determined based on a plurality of histograms related to the plurality of predetermined types of the first predetermined property, respectively. For example, in the case of the predetermined types of the first predetermined property being green, amber, and red colours, histograms of green, amber, and red colours may be separately determined.

In various embodiments, the first predetermined property is a colour of the signal light and the plurality of predetermined types is a plurality of predetermined types of colour. For example, in the case of detecting a traffic light, the predetermined types of colour may be the predetermined colours of traffic signal light that may be output by the traffic light, such as green, amber and red colours.

In various embodiments, identifying a plurality of candidate light blobs from the plurality of light blobs in the dark frame further comprises applying a predetermined threshold to the saliency map generated as described above to obtain a saliency mask. Accordingly, the saliency mask may be a binary image. From the saliency mask, a plurality of groups of neighbouring pixels (each group of neighbouring pixels having common property labels) may then be identified as the plurality of candidate light blobs, respectively. For example, a group of neighbouring pixels having common property labels may be considered as a candidate light blob having the common property label. In various embodiments, multiple pixels are neighbouring pixels if they are adjacent each other, such as immediately adjacent. In various embodiments, a centroid-based clustering technique may be adopted to group neighbouring pixels as one group, and a pixel is assigned to the nearest cluster center.

In further embodiments, the signal light to be detected has a second predetermined property, and for each of the plurality of candidate light blobs, determining whether to discard the candidate light blob from the plurality of candidate light blobs based on a second property of the candidate light blob in the saliency mask with respect to the second predetermined property. For example and without limitation, the second predetermined property may be a shape of the signal light (e.g., for a traffic light, the predetermined shape may be round or circular), and the candidate light blob may be discarded if the shape of the candidate light blob (e.g., shape formed by the group of neighbouring pixels having common property labels as described above) is determined to not satisfy or conform with the second predetermined property (e.g., not substantially or sufficiently circular). In this regard, utilizing a saliency mask significantly enhances the appearance of the candidate light blobs, such as the contrast or the outlines/contours of candidate light blobs, thus facilitating the detection of various properties of the candidate light blobs, such as the shape thereof, for evaluating whether any of the candidate light blobs should be discharged depending on whether one or more physical properties of the candidate light blobs conform with expected (or predetermined) one or more physical properties of the signal light being detected. Accordingly, such an approach facilitates the robust detection of candidate light blobs from the dark frame.

As described hereinbefore, a plurality of candidate regions, corresponding respectively to the plurality of candidate light blobs identified from the dark frame, is identified in the bright frame. In various embodiments, for each of the plurality of candidate light blobs, a corresponding light blob in the bright frame is located based on a position of the candidate light blob from the dark frame, and a corresponding candidate region in the bright frame is identified based on a position of the located corresponding light blob in the bright frame. In various embodiments, the dark and bright frames may be obtained at different time instances (e.g., one after another), and thus there may be motion between the dark and bright frames obtained. Accordingly, the corresponding light blob in the bright frame is advantageously located first (to address the relative motion that occurred between the dark and bright frames), and then the corresponding candidate region in the bright frame is identified based on the position of the located corresponding light blob. Example technique(s) of locating the corresponding light blob and the corresponding candidate region in the bright frame will be described later below according to various example embodiments of the present invention.

In various embodiments, each of the plurality of candidate light blobs is classified using a classifier trained with respect to a plurality of predetermined types of classes. In this regard, classifying each of the plurality of candidate light blobs comprises processing the candidate region corresponding to the candidate light blob to classify the candidate region under one of the plurality of predetermined types of classes, and labeling the candidate light blob with a class label corresponding to the one of the plurality of predetermined types of classes which the corresponding candidate region is classified under. Furthermore, whether one or more of the plurality of classified candidate light blobs is a signal light from the particular type of signaling device is evaluated based on the respective class labels associated with the one or more classified candidate light blobs. Accordingly, after the robust detection of the candidate light blobs from the dark frame, corresponding candidate regions are identified in the bright frame and the type of classes which the candidate light blob belongs to is advantageously classified based on the corresponding candidate region in the bright frame which has rich texture information, thus enhancing the accuracy of the classification of the candidate light blob, afforded by the greater detail level (e.g., context/texture information) of the corresponding candidate region. Accordingly, for example, the trade-off associated with conventional signal light detection devices is advantageously addressed, or at least mitigated, according to various embodiments of the present invention.

In various embodiments, at least one of the classified candidate light blobs (e.g., all classified candidate light blobs) evaluated to be the signal light (e.g., based on the associated class label) is tracked for a series of bright frames to obtain a trajectory (e.g., movement trajectory) associated with the classified candidate light blob. Subsequently, the at least one of the classified candidate light blobs evaluated to be the signal light (by the above-described classifier) is verified to determine whether it is the signal light based on one or more characteristics of the trajectory associated thereto. For example, for a series of bright frames, candidate light blobs may be classified and a number of the classified candidate light blobs may be evaluated to be a signal light desired to be detected as described above. In this regard, the trajectory tracking a light blob evaluated to be the signal light may be analysed based on a number of expected or predetermined characteristics associated with the signal light desired to be detected. For example and without limitation, the trajectory may be expected to follow an expected path, and the candidate light blob associated with the trajectory may be affirmed or rejected/discharged based on whether the trajectory sufficiently follows the expected path. Such an approach further enhances the accuracy/reliability of the signal light detection according to various embodiments of the present invention. Exemplary technique(s) of tracking and verifying classified candidate light blobs will be described later below according to various example embodiments of the present invention

In various embodiments, the particular type of signaling device is a traffic light, and the plurality of predetermined types of colours comprises green, amber, and red. It will be appreciated that the colour scheme for traffic light typically includes green, amber, and red, but the present invention is not limited to such a colour scheme, and other colour schemes if adopted are also within the scope of the present invention.

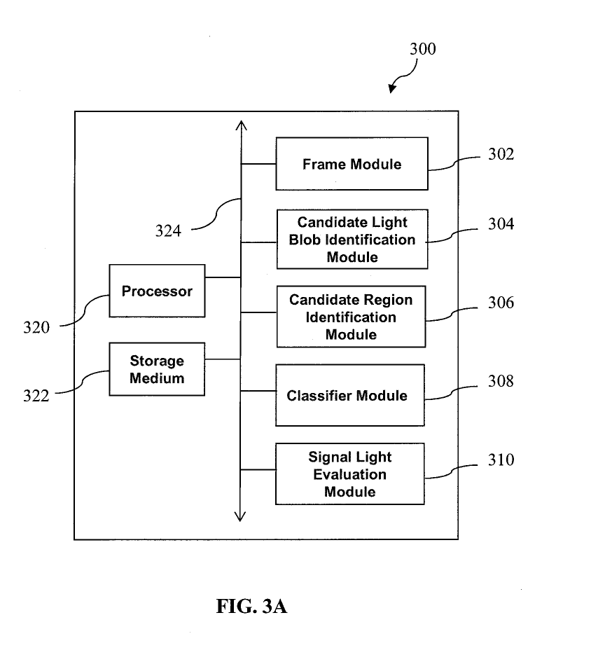

FIG. 3A depicts a schematic drawing of a signal light detection device 300 according to various embodiments of the present invention. The device 300 comprises a frame module or circuit 302 configured to obtain a dark frame and a bright frame of an environment, the dark frame and the bright frame each comprising a plurality of light blobs corresponding to lights captured in the environment, a candidate light blob identification module or circuit 304 configured to identify a plurality of candidate light blobs from the plurality of light blobs in the dark frame, a candidate region identification module or circuit 306 configured to identify a plurality of candidate regions in the bright frame based on the plurality of candidate light blobs identified from the dark frame, a classifier module or circuit 308 configured to classify each of the plurality of candidate light blobs based on the corresponding candidate region from the bright frame, and a signal light evaluation module or circuit 310 configured to evaluate whether one or more of the plurality of classified candidate light blobs is a signal light from a particular type of signaling device.

In various embodiments, the signal light detection device 300 further comprises a tracking module or circuit configured to track at least one of the classified candidate light blobs evaluated to be the signal light from the particular type of signaling device for a series of bright frames to obtain a trajectory associated to the classified candidate light blob, and to verify whether the at least one of the classified candidate light blobs evaluated to be the signal light is the signal light based on one or more characteristics of the trajectory associated thereto. In this regard, FIG. 3B depicts a schematic drawing of a signal light detection device 350 further comprising the tracking module or circuit 352 according to various embodiments of the present invention.

As shown in FIGS. 3A and 3B, the signal light detection device 300/350 may further comprise a computer processor 320 capable of executing computer-executable instructions (e.g., frame module 302, candidate light blob identification module 304, candidate region identification module 306, classifier module 308, and/or signal light evaluation module 310) to perform one or more functions for signal light detection and a computer-readable storage medium 322 communicatively coupled to the processor 320 having stored therein one or more sets of computer-executable instructions. Various components of the signal light detection device 300/400 may communicate via an interconnected bus 324 in a manner known to a person skilled in the art.

It will be appreciated that the signal light detection device 300/350 may, for example, be an image capturing device (e.g., still and/or video camera) comprising (e.g., integrated with) the above-mentioned modules (e.g., a frame module 302, a candidate light blob identification module 304, a candidate region identification module 306, a classifier module 308, and/or a signal light evaluation module 310) configured for signal light detection, or a separate or stand-alone computing device comprising the above-mentioned modules capable of being communicatively coupled (e.g., via any networking interface according to any wireless or wired protocol known in the art) to one or more image capturing devices, e.g., for obtaining the dark and bright frames therefrom and then processing the dark and bright frames obtained in the manner as described hereinbefore for signal light detection. In various embodiments, the dark frame and the bright frame may be obtained one after another (e.g., consecutive frames in time) from an image capturing device (e.g., the image capturing device capturing a dark frame first and then followed by capturing a bright frame). In various other embodiments, the dark frame and the bright frame may be obtained substantially simultaneously, such as from two image capturing devices, respectively, one image capturing device being configured to capture dark frames and the other image capturing device being configured to capture bright frames. By way of examples only and without limitation, an image capturing device may be a still and/or video camera, a car video recorder, a car navigation system (with image capturing functionality), a portable or mobile phone (e.g., smartphone with image capturing functionality), and so on.

In various embodiments, the environment may be any environment in which a signal light from a particular type of signaling device is desired to be detected, such as an outdoor environment, e.g., along a street or a road. A frame of the environment may thus be obtained or captured from the perspective of the image capturing device, such as the environment in front of the image capturing device.

In various embodiments, the status of a signaling device may be determined based on the class label of one or more light blobs detected to be a signal light from the signaling device. For example, in the case of a traffic light, and if the light blob detected to be a signal light from the signal device has a class label indicating a red colour, the status of the traffic light is determined to be “stop”.

A computing system, a controller, a microcontroller or any other system providing a processing capability may be presented according to various embodiments in the present disclosure. Such a system may be taken to include one or more processors and one or more computer-readable storage mediums. For example, as mentioned above, the signal light detection device 300/350 described herein includes a processor (or controller) 320 and a computer-readable storage medium (or memory) 322 which are for example used in various processing carried out therein as described herein. A memory or computer-readable storage medium used in various embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In various embodiments, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g., any kind of computer program, e.g., a computer program using a virtual machine code such as e.g., Java. Any other kind of implementation of the respective functions which will be described in more detail below may also be understood as a “circuit” in accordance with various alternative embodiments. Similarly, a “module” may be a portion of a system according to various embodiments in the present invention and may encompass a “circuit” as above, or may be understood to be any kind of a logic-implementing entity therefrom.

Some portions of the present disclosure are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “obtaining”, “identifying”, “classifying”, “evaluating”, “labeling” “tracking”, “verifying”, “processing” or the like, refer to the actions and processes of a computer system, or similar electronic device, that manipulates and transforms data represented as physical quantities within the computer system into other data similarly represented as physical quantities within the computer system or other information storage, transmission or display devices.

The present specification also discloses a system or an apparatus for performing the operations/functions of the methods described herein. Such a system or apparatus may be specially constructed for the required purposes, or may comprise a general purpose computer or other device selectively activated or reconfigured by a computer program stored in the computer. The algorithms presented herein are not inherently related to any particular computer or other apparatus. Various general purpose machines may be used with computer programs in accordance with the teachings herein. Alternatively, the construction of more specialized apparatus to perform the required method steps may be appropriate.

In addition, the present specification also at least implicitly discloses a computer program or software/functional module, in that it would be apparent to the person skilled in the art that the individual steps of the methods described herein may be put into effect by computer code. The computer program is not intended to be limited to any particular programming language and implementation thereof. It will be appreciated that a variety of programming languages and coding thereof may be used to implement the methods/techniques of the disclosure contained herein. Moreover, the computer program is not intended to be limited to any particular control flow. There are many other variants of the computer program, which can use different control flows without departing from the spirit or scope of the invention. It will be appreciated to a person skilled in the art that various modules described herein (e.g., the frame module 302, the candidate light blob identification module 304, the candidate region identification module 306, the classifier module 308, and/or the signal light evaluation module 310) may be software module(s) realized by computer program(s) or set(s) of instructions executable by a computer processor to perform the required functions, or may be hardware module(s) being functional hardware unit(s) designed to perform the required functions. It will also be appreciated that a combination of hardware and software modules may be implemented.

Furthermore, one or more of the steps of the computer program/module or method may be performed in parallel rather than sequentially. Such a computer program may be stored on any computer readable medium. The computer readable medium may include storage devices such as magnetic or optical disks, memory chips, or other storage devices suitable for interfacing with a general purpose computer. The computer program when loaded and executed on such a general-purpose computer effectively results in an apparatus that implements the steps of the methods described herein.

In various embodiments, there is provided a computer program product, embodied in one or more computer-readable storage mediums (non-transitory computer-readable storage medium), comprising instructions (e.g., the frame module 302, the candidate light blob identification module 304, the candidate region identification module 306, the classifier module 308, and/or the signal light evaluation module 310) executable by one or more computer processors to perform a method 200 of signal light detection as described hereinbefore with reference to FIG. 2 or other method(s) described herein. Accordingly, various computer programs or modules described herein may be stored in a computer program product receivable by a computer system or electronic device (e.g., the signal light detection device 300/350) therein for execution by a processor of the computer system or electronic device to perform the respective functions.

The software or functional modules described herein may also be implemented as hardware modules. More particularly, in the hardware sense, a module is a functional hardware unit designed for use with other components or modules. For example, a module may be implemented using discrete electronic components, or it can form a portion of an entire electronic circuit such as an Application Specific Integrated Circuit (ASIC). Numerous other possibilities exist. Those skilled in the art will appreciate that the software or functional module(s) described herein can also be implemented as a combination of hardware and software modules.

It will be appreciated to a person skilled in the art that the terminology used herein is for the purpose of describing various embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof.

In order that the present invention may be readily understood and put into practical effect, various example embodiments of the present invention will be described hereinafter by way of examples only and not limitations. It will be appreciated by a person skilled in the art that the present invention may, however, be embodied in various different forms or configurations and should not be construed as limited to the example embodiments set forth hereinafter. Rather, these example embodiments are provided so that this disclosure will be thorough and complete, and will fully convey the scope of the present invention to those skilled in the art.

In particular, for better understanding of the present invention and without limitation or loss of generality, various example embodiments of the present invention will now be described whereby the particular type of signaling device is a traffic light, and the signal light being detected is the traffic signal light from the traffic light. However, it will be appreciated by a person skilled in the art that the present invention is not limited to detecting traffic signal light from a traffic light and the signal light detection method and device may be implemented to detect signal light from other types of signaling device, such as but not limited to, vehicle brake light, vehicle indicator light, and so on.

As mentioned in the background, robust traffic light detection is important for, e.g., autonomous vehicles. For example, varying illumination conditions and analogical false alarms are two key challenges in real-world scenarios. Various example embodiments of the present invention address such challenges. According to various example embodiments of the present invention, prior detection masks may first be generated to limit the potential image regions. A dual-channel detection and/or recognition technique/framework may then be applied. With such an approach, traffic light candidates may be robustly detected from dark frames and may be accurately classified using a deep neural network in consecutive high-shutter bright frames. Such a dual-channel mechanism may thus make full use of undistorted colour and shape information in dark frames as well as rich context in bright frames.

According to various example embodiments, in the dark channel, a non-parametric multi-colour saliency model may be implemented to simultaneously extract lights with different colours. Then in the bright channel, a multi-class classification model (e.g., preferably a convolutional neural network (CNN) classifier, such as including 13 different classes) may be adopted to remove false alarms/detections (e.g., removing false candidate traffic light blobs or light blobs incorrectly detected as being traffic signal lights). In further subsequent embodiments, the performance may be further boosted by incorporating temporal trajectory tracking. Experiments performed based on a dual-channel dataset demonstrated the effectiveness and efficiency (20 fps) of the traffic light detection according to various example embodiments of the present invention.

FIG. 4 depicts a schematic block flow diagram of an exemplary method 400 of traffic signal light detection according to various example embodiments of the present invention. As shown in FIG. 4, the method 400 is based on dual-channel (or dual-channel object detection pipeline), namely, a dark channel 403 and a bright channel 405. The method 400 may be considered to involve three modules or sections as shown in FIG. 4, namely, a first module 405 relating to detection in dark frames, a second module 407 relating to classification in bright frames, and a third module 409 relating to temporal tracking and decision making For example, the first module 405 may include or relate to the candidate light blob identification module 304 described hereinbefore, the second module 407 may include or relate to the candidate region identification module 306 and the classifier module 308 described hereinbefore, and the third module 409 may include or relate the tracking module 352 described hereinbefore with reference to FIG. 3A and/or FIG. 3B.

In the first module 405, candidate light blobs are detected in a dark channel 403 where exposure is set very low to dim most non-luminous objects (or passive lighting objects). By way of an example only and without limitation, for a Zebra 2 PGEHD-20S4C camera used in various experiments performed according to various example embodiments, the gain values were set to be 50 and 380 for the dark and bright channels, respectively, and the shutter values were set to be 500 and 1000 for dark and bright channels, respectively. Detecting in a dark channel helps to remove false alarms that have similar appearance as traffic signal lights, such as red balloons or traffic signs. A non-parametric multi-colour saliency model may then applied to simultaneously extract highlighted/labelled light blobs of three colours, namely, red, green and amber. Based on these colour labelled light blobs, in the second module 407, candidate regions in the latest bright frame may be identified or refined, and fed into a CNN classifier, resulting in light blobs with class labels. To further improve the detection smoothness, in the third module 409, temporal spatial trajectory tracking phase may be implemented to verify the dependability of the light blobs classified as being traffic signal lights, upon which a conclusion may then be drawn on the traffic light status. The exemplary method 400 of traffic signal light detection will now be described in further details according to various example embodiments of the present invention.

Based on homogeneous projection matrix of image formulation as shown in Equation 1 below, the projection matrix from a three-dimensional (3D) world coordinates to two-dimensional (2D) image plane may be computed as shown in Equations 2 and 3 below.

$$\begin{matrix}[ \begin{matrix}U \\ V \\ t\end{matrix} ] = [ \begin{matrix}{M}_{00} & {M}_{01} & {M}_{02} & {M}_{03} \\ {M}_{10} & {M}_{11} & {M}_{12} & {M}_{13} \\ {M}_{20} & {M}_{21} & {M}_{22} & {M}_{23}\end{matrix} ] [ \begin{matrix}x \\ y \\ z \\ 1\end{matrix} ] , [ \begin{matrix}u \\ v\end{matrix} ] = [ \begin{matrix}U / t \\ V / t\end{matrix} ] & ( 1 ) \\ u = \frac{{M}_{00} x + {M}_{01} y + {M}_{02} z + {M}_{03}}{{M}_{20} x + {M}_{21} y + {M}_{22} z + {M}_{23}} & ( 2 ) \\ v = \frac{{M}_{10} x + {M}_{11} y + {M}_{12} z + {M}_{13}}{{M}_{20} x + {M}_{21} y + {M}_{22} z + {M}_{23}} & ( 3 )\end{matrix}$$

If accurate vehicle localization and position are available, as well as the pre-stored 3D localization of traffic lights, pixel location in the image plane may be computed, and then traffic light status may be easily verified using colours, shapes or weaker classifiers. However, such techniques rely on the high accuracy of map and localization, which may not be practical in general. In contrast, according to various example embodiments of the present invention, a coarse range of the relative position of the traffic lights may be utilized to estimate the potentially appearing areas in the image plane. In this regard, according to various example embodiments, the first module 405 may include a prior detection mask module 411 for determining a prior detection mask to provide/extract a detection region of interest for detecting one or more particular types of traffic signal lights. By way of examples only and without limitation, the detection ranges for vertically hanged traffic lights in three directions may be set to [0 m, 60 m] in longitudinal detection (x-axis), [−8 m, 8 m] in lateral direction (y-axis), and [2.5 m, 4 m] in height direction (z-axis). In various example embodiments, the x-axis points forward toward the front of the vehicle but lies in the ground plane where positive x is forward, the y-axis points toward the left-hand side of the vehicle but lies in the ground plane where positive y is left, and the z-axis points up and perpendicular to the ground where positive z is up. The coordinate center may be defined as the projection of the camera center on the ground.

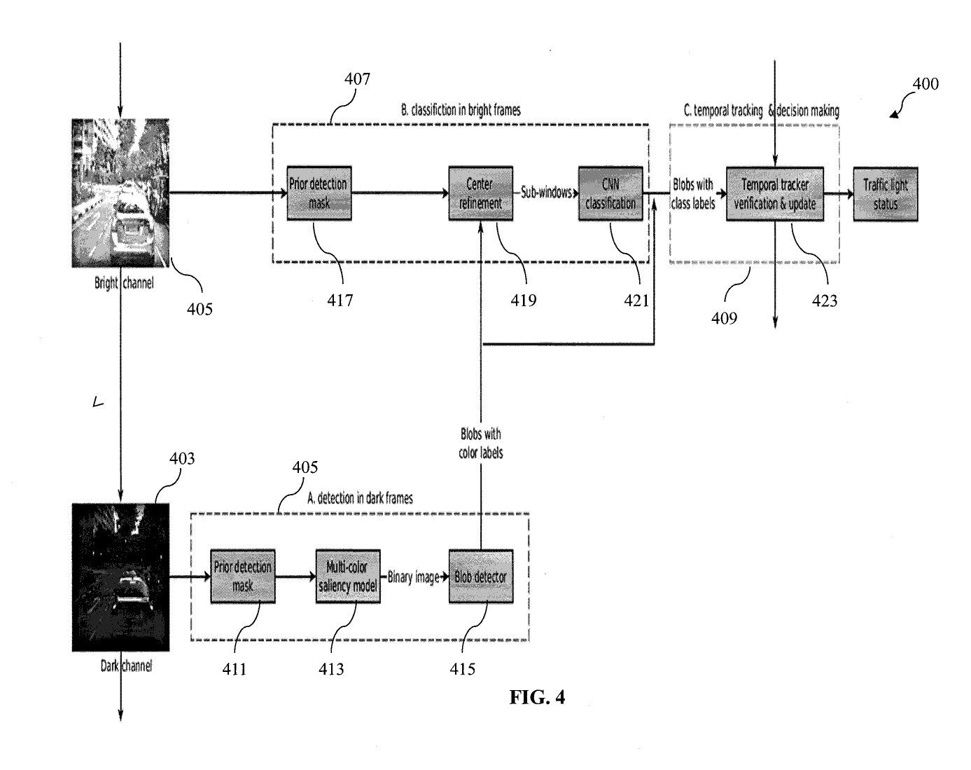

For example, to obtain the prior detection region in 2D, various 3D values (i.e., (x, y, z) values) may be computed by incrementing x, y, and z in small steps, and then substituting such 3D values into Equations 2 and 3 above to obtain the corresponding 2D values. The resulting prior detection region for the above example of detecting vertically hanged traffic lights is shown in FIG. 5G. As another example, FIG. 5H shows the prior detection mask obtained for detecting horizontally hanged traffic lights, which differ in height direction compared the example of vertically hanged traffic light with a range of [4.5 m, 7 m]. In various example embodiments, if rough information of the vehicle position and traffic light localization is accessible, such prior detection masks may be further shrunk to narrow the search region. By way of examples only and without limitation, FIGS. 5A to 5F illustrate further example prior detection masks obtained for various detection ranges. In general, the more accurate the prior location information of objects can be obtained, the smaller the prior detection mask may be.

The first module 405 further includes a multi-colour saliency model 413 (e.g., related to the “candidate light blob identification module” 306 described hereinbefore) configured to facilitate the identification of candidate light blobs from the plurality of light blobs in the dark frame. That is, multi-colour saliency model learning may be implemented. The candidate light blobs corresponding to traffic signal lights are detected in the dark frames. Within the prior detection mask, color is an important clue to detect traffic signal lights and recognize their status. In this regard, conventional methods may utilize various color spaces and tuned color thresholds to detect color blobs of traffic signal lights. This usually requires specific colour parameters to be set for detecting different colours (e.g., red, green and amber), but such colour parameters are sensitive to lighting conditions. As each pixel needs to be verified, the processing time may grow linearly with the number of colors.

In contrast, various example embodiments of the present invention provides a color parameter free model to simultaneously extract light blobs of various colors at approximately the same time. For simplicity, the three-dimensional (3D) RGB color space is utilized in various example embodiments of the present invention. First, the 3D RGB color space may be partitioned to M×M×M grids, for example and without limitation, the parameter “M” may be set to 32. Subsequently, the histograms of red, green and amber colors may be separately calculated from corresponding subsets of red, green and amber traffic light samples (i.e., reference samples). In this regard, let Hᵣ, H_{g}, and Hₐ be the normalized histograms of red, green, and amber colours. According to various example embodiments, normalization may include three steps: (1) the raw histogram is normalized to the range of [0, 1], (2) the normalized histogram obtained from step (1) is truncated by a threshold (e.g., 0.1), and (3) the resulting histogram obtained in step (2) is normalized to [0, 1]. In this regard, the truncation may function to prevent extreme dominance of single color bin.

With the histograms of red, green, and amber colours (learned histogram models for red, green, amber colours, respectively, denoted as Hᵣ, H_{g}, and Hₐ) computed, given an input image (e.g., a region of the dark frame obtained after applying the prior detection mask), a red saliency score of a pixel (i, j) may be computed by:

$${S}_{r} ( i , j ) = {\sum }_{( {i}^{′} , {j}^{′} ) ∈ {N}_{d} ( i , j )} {H}_{r} ( {i}^{′} , {j}^{′} ) \qquad ( 4 )$$

where N_{d}(i, j) represents neighbouring pixels of pixel (i, j) within a maximal distance of d. Then a saliency mask may be obtained by simply applying a predetermined threshold T to the saliency image Sᵣ, for example, d=2 and T=0.2. However, it will be appreciated by a person skilled in the art that the settings, e.g., the predetermined threshold (T) and distance (d) parameters, are not limited to the above-mentioned values and appropriate values may be determined or optimized through appropriate tuning.

With the learned histogram models for different light types, separate saliency maps may be obtained, that is, one saliency map for each light type. However, according to various example embodiments, it is identified that computing the saliency score of each pixel one time for each color is computationally redundant or ineffective. To address this issue, according to various example embodiments, the color models of different colors are advantageously fused together to produce an overall saliency map, for example, by applying a maximum operator (MAX) to merge the normalized histograms of red, green and amber colors as follow:

H=max(Hᵣ, H_{g}, Hₐ) (5)

The overall saliency map may thus be generated by replacing Hᵣ in Equation 4 with H in Equation 5 as shown in Equation 6 below:

$$S ( i , j ) = {\sum }_{( {i}^{′} , {j}^{′} ) ∈ {N}_{d} ( i , j )} H ( {i}^{′} , {j}^{′} ) \qquad ( 6 )$$

In various example embodiments, if the saliency score for a pixel is above the predetermined threshold (T), the three channel (individual/separate) histogram models are then further applied to compute channel (individual/separate) saliency scores, and the color type of the pixel is considered as the color achieving the maximal/highest individual saliency score amongst the three individual saliency scores. With such an approach, the majority of pixels may be filtered out by the overall saliency score, and the types of remaining small portion of pixels may then be determined by individual saliency models, thus significantly enhancing computational efficiency.

For illustration purposes, FIGS. 6A and 6B depict example raw bright and dark frames obtained, respectively, and FIGS. 6C and 6D depict example saliency map and saliency mask (binarized saliency map) obtained, respectively, from the dark frame shown in FIG. 6B according to various example embodiments of the present invention. It will be appreciated to a person skilled in the art that the raw bright frame obtained may actually be a colour image, but is shown as a black and white image in FIG. 6A. In FIG. 6D, candidate light blobs identified as green and amber lights are shown labelled with green and amber labels. The remaining candidate light blobs shown in FIG. 6D have been identified as red lights in the example and are also labelled with red labels, but the red labels are not illustrated in FIG. 6D.

The first module 405 further includes a blob detector module 415 (e.g., related to the “candidate light blob identification module” 306 described hereinbefore) configured to analyse the candidate light blobs in the saliency mask based on shape criteria (e.g., corresponding to the “second predetermined property” described hereinbefore) to determine or verify whether any of the plurality of candidate light blobs may remain as candidate light blobs or be discarded from the plurality of candidate light blobs. For example, with the contours of the candidate light blobs extracted from the saliency mask (binary image), shape criteria may be adopted to remove those candidate light blobs that do not satisfy or conform to expected properties (e.g., clearly incorrect light blobs), such as based on predetermined shape critera, including the area of the light blobs in pixels and/or their circularity.

In the second module 407, based on the detected candidate light blobs from the dark frame, corresponding sub-images (e.g., corresponding to “candidate regions” described hereinbefore) with richer texture are obtained from a subsequent (e.g., next) bright frame. In the second module 407, similar to the prior detection mask module 411 for the dark frame, a prior detection mask module 417 is utilized for determining a prior detection mask to provide/extract a detection region of interest in the bright frame for detecting one or more particular types of traffic lights. In various embodiments, the prior detection mask module 417 may simply apply the same prior detection mask as determined by the prior detection mask module 411 described hereinbefore.

However, due to the motion between consecutive frames, a center refinement module 419 is provided and configured to implement center refinement according to various example embodiments to ensure the sub-images are cropped having canonical center. In various example embodiments, the center position p and radius r of the light blobs may be evaluated in the dark frame. In the subsequent bright frame, a new center corresponding to a candidate light blob from the dark frame is searched within, e.g., a 12r×12r image window in the bright frame centered at the center position p. In this regard, it is recognized according to various example embodiments of the present invention that the light center normally has highest color saturation and brightness in the image window. Based on the RGB space, the variance image:

$$V = \frac{\vert R - G \vert + \vert R - B \vert + \vert G - B \vert}{2} \qquad ( 7 )$$

and brightness image:

$$B = \frac{R + G + B}{3} \qquad ( 8 )$$

are computed. The new center in the bright frame corresponding to the candidate light blob from the dark frame may then be found at the highest response in a weighted image:

αV+(1−α)B (9)

where α=0.7. For example, the R, G and B are represented as the matrices with the same dimension, so Equations 7 to 9 can be computed (i.e. normal matrix computing). From the resulting matrix derived from Equation 9, the largest element may be identified which is the location of the highest response. With the new center determined, the corresponding candidate region to the candidate light blob may then be identified or extracted, such as a region of the bright frame within a predetermined distance from the new center. For example, a corresponding candidate region may be cropped from the bright frame as a 21r×21r region centered at the new center in bright frames.

In practice, there may often be various false alarms/detections (e.g., falsely or incorrectly detected candidate light blobs), such as from brake lights and other shining objects. According to various example embodiments, to further enhance performance, a CNN classifier is trained to distinguish the true positive from false alarms/detections. In particular, the second module 407 may comprise a CNN classifier 421 configured to classify each of the plurality of candidate light blobs based on the corresponding candidate region from the bright frame. For example, as mentioned above, an image patch (candidate region) may be cropped as a 21r×21r region centered at the new center in the bright frame. The CNN classifier 421 may be customized based on the classic model, of which is well known in the art and thus need not be described herein for sake of conciseness.

As an exemplary implement and without limitation, the number of output in the last layer may be 13, being 12 positive classes and one background class. By way of examples only and without limitation, the positive classes may include horizontally aligned red light (HARL), vertically aligned red light (VARL), horizontally aligned green light (HAGL), vertically aligned green light (VAGL), left vehicle light (LVL), right vehicle light (RVL), green arrow light (GAL), red arrow light (RAL), amber light (AL), green pedestrian light (GPL), red pedestrian light (RPL) and other fake red light (OFRL). A reason for class selection is to reduce the within-class variance (split horizontal and vertical lights) and learn to distinguish red lights from common false alarms (e.g., LVL, RVL and OFRL classes), while trying to limit the data collection and annotation effort. In addition, as real-time performance is critical in practical use, the size of the input image may be restricted to a predetermined maximum size, such as but not limited to, 111×111 pixel units in various example implementations. In various example embodiments, to keep the main body of the original architecture (e.g, layers 2 to 8 of AlexNet), the first convolutional layer may be modified, such as but not limited to, adjusting the kernel size from 7 to 3, and the stride from 4 to 2.

In various example embodiments, a fine tuning technique is utilized to train the weights of the CNN classifier 421 using Caffe Tool, of which is well known in the art and thus need not be described herein in detail for conciseness. In various example implementations, the basic learning rate and decay weight are set to 0.001 and 0.0005. The multipliers of learning rate for modified layers, i.e., the first convolutional layer and the output layer, are set to 10 in first 2000 iterations, and then set back to 1 as other layers. In total, the training procedure may take about 50,000 iterations.

With the trained classifier 421, each of the plurality of candidate light blobs may then be classified as belonging to one of the predetermined types of classes and labelled with a corresponding class label (i.e., corresponding to the type of class which the candidate light blob is classified under). Thereafter, whether one or more of the plurality of classified candidate light blobs is a traffic signal light may then be evaluated based on the associated class labels. Furthermore, the status of the traffic light may also be detected or recognized based on the class label of the light blobs evaluated to be a traffic signal light, for example, a class label of HARL means “stop”, and a class label of HAGL means “Go”.

In various example embodiments, a tracking module 423 is implemented to further enhance the accuracy or reliability of traffic signal light detection. In this regard, it has been identified according to various example embodiments that temporally, traffic light status keeps consistency for certain period of time in practice. Meanwhile, location history of the light blobs in the image plane is spatially continuous. Accordingly, temporal spatial tracking is implemented according to various example embodiments to greatly benefit the traffic signal light detection, for example, in the following two aspects. On the one hand, temporal spatial tracking has been found to improve the result smoothness by filling light status to middle frames with missing or unconfident detections. On the other hand, temporal spatial tracking has also been found to improve the detection confidence and reduce isolated false alarms. Overall, the tracking module 423 may be configured to track two properties, namely, the spatial location of detected instances (e.g., light blobs evaluated by the classifier 421 to be a traffic signal light) and the traffic signal light status history.

The tracking history of a light instance (light blob) may be considered or referred to as a trajectory (or movement trajectory). In various example embodiments, the trajectory may have associated therewith a number of parameters or characteristics, such as but not limited to, vector/set of points representing information on location history, age (i.e., length of time), and discontinuity. The trajectory may be categorized/classified in terms of three colors and one Boolean flag indicating the trajectory stability, which may then result in six types of trajectory categories or classes, namely, stable red, stable green, stable amber, temporary red, temporary green, and temporary amber. For example, a stable red trajectory may mean that the trajectory has been confirmed/verified as the tracking of a red traffic light (horizontal or vertical lights are not separated). The age parameter may be configured to indicate the existing period (length of time) of the trajectory since the first detection of a traffic light instance at the beginning of the trajectory, and the discontinuity parameter may be configured to record the number of passed frames (previous frames) since last detection of the instance. For example, a trajectory may be created once a new candidate traffic light blob is found to be stable (e.g., there are at least N (e.g. five) continuous frames in which the light blob can be detected in near locations of the image. With such an approach, some false alarms, such as candidate traffic light blob detected only in one frame, can be removed.

In various embodiments, a trajectory pool (e.g., maintained in the storage medium 322) may be provided to store or maintain existing trajectories and may be updated after every frame. For example, at an initial stage (e.g., at the very beginning), every trajectory is initialized as a temporary trajectory. For example and without limitation, a predetermined minimal duration or age (e.g., 1 second) and a predetermined minimal number of detections of the light instance (e.g., 5 times) may be required for re-categorising a temporary trajectory to a stable trajectory. A trajectory may also be removed from the trajectory pool when its age is above a predetermined time period, such as but not limited to, 70 seconds. Typically, the duration of red, green or amber lights is below 70 seconds. At times, the duration of the red light may be longer than 70 seconds. However, according to various example embodiments, the tracking of such a light blob is split into two trajectories (e.g., a second trajectory is generated after 70 seconds).

Therefore, according to various example embodiments, given an input bright image, traffic light blobs may first be detected using the aforementioned dual-channel fusion technique. These newly detected traffic light blobs (e.g., evaluated by the classifier 421 to be a traffic signal light) may then be added into the trajectory pool. As an example, suppose a red traffic light blob is detected in the current frame (e.g., light blob classified as a red traffic light), the trajectories associated with red colour (red trajectories) in the trajectory pool are traversed and verified by calculating the distance between the newly detected red light blob and the existing red trajectories (e.g., each traffic light corresponds to one trajectory). In other words, the location of the newly detected red light blob is compared with existing red trajectories. For example, if the distance between the newly detected red light blob and an existing red trajectory (e.g., with respect to the latest red light blob associated with the red trajectory) is within (e.g., below) a predetermined threshold (e.g., 60-pixel distance), the newly detected red light blob (e.g., a new point corresponding to the newly detected red light blob) is added into that red trajectory. On the other hand, if no valid trajectory is found, then a new temporary red trajectory may be created for the newly detected red light blob. In this manner, when a stable trajectory is found, it may be determined with a high degree of confidence that the newly detected red light blob is a stable red traffic signal light. On the other hand, if only a temporary trajectory is found, then the newly detected red light blob is considered as a temporary red signal light, which may occasionally be a false alarm.

According to various example embodiments, the traffic light status of a current frame may be decided based on the class label associated with one or more verified light blobs detected (e.g., verified by the tracking module 423), for example, based on all the light blobs verified in a frame. For example, a single verified light blob labelled with red light (e.g., VARL) indicates that the traffic light status is stop in all directions, and two verified light blobs labelled as red light and green left arrow, respectively, indicate that the traffic light status is stop in a forward direction but turning left is allowed. In further embodiments, the overall or final status of a traffic light may be determined sequentially based on the following criteria. First, if the number of all light blobs detected (verified) in a frame of a certain color exceeds other types by at least two, then the status of the traffic light may be determined confidently to be of that color type. For example, two or more red lights (e.g., one horizontal red light and one red vertical light) may be detected at a junction, thus, confidently indicating the status of the traffic light as stop. Otherwise, if the number of stable light blobs detected of a certain color exceeds other types, then the status of the traffic light may also be determined confidently to be of that color type. In this regard, the CNN classifier 421 and stable trajectory requirements imposed by the tracking module 423 enhances the reliability of the light blobs detected to be stable. On the other hand, if the above-mentioned two criteria are not applicable (e.g., if the detection results from the current frame do not satisfy the conditions of the two criteria above), the status of the traffic light may then be drawn from statistics on the status of a predetermined number of previous frames, such as but not limited to, the previous 20 frames. Accordingly, in various example embodiments, the temporal history of traffic light status is utilized to enhance the smoothness and stability of traffic signal light detection.

While embodiments of the invention have been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A method of signal light detection, comprising:
obtaining a dark frame of an environment, the dark frame comprising a plurality of light blobs corresponding to lights captured in the environment;
obtaining a bright frame of the environment, the bright frame comprising a plurality of light blobs corresponding to lights captured in the environment;
identifying a plurality of candidate light blobs from the plurality of light blobs in the dark frame;
identifying a plurality of candidate regions in the bright frame based on the plurality of candidate light blobs identified from the dark frame;
classifying each of the plurality of candidate light blobs based on the corresponding candidate region from the bright frame; and
evaluating whether one or more of the plurality of classified candidate light blobs is a signal light from a particular type of signaling device.

2. The method according to claim 1, wherein the signal light to be detected has a first predetermined property, and wherein identifying a plurality of candidate light blobs comprises:
generating a saliency map based on the dark frame with respect to the first predetermined property; and
for each pixel of the saliency map that has a saliency score above a predetermined threshold, labeling the pixel with a property label related to the first predetermined property.

3. The method according to claim 2, wherein the saliency score is an overall saliency score determined for each of a plurality of pixels of the dark frame with respect to a plurality of predetermined types of the first predetermined property,
said identifying a plurality of candidate light blobs further comprises determining, for each pixel of the saliency map that has an overall saliency score above the predetermined threshold, individual saliency scores for the pixel with respect to the plurality of predetermined types of the first predetermined property, respectively, and
said labeling the pixel comprises labeling the pixel with a property label corresponding to one of the plurality of predetermined types of the first predetermined property.

4. The method according to claim 3, wherein the overall saliency score is determined based on a plurality of histograms related to the plurality of predetermined types of the first predetermined property, respectively.

5. The method according to claim 3, wherein the first predetermined property is a colour of the signal light and the plurality of predetermined types is a plurality of predetermined types of colour.

6. The method according to claim 2, wherein said identifying a plurality of candidate light blobs further comprises:
applying a predetermined threshold to the saliency map to obtain a saliency mask;
identifying a plurality of groups of neighbouring pixels in the saliency mask as the plurality of candidate light blobs, respectively, each group of neighbouring pixels having common property labels; and
wherein the signal light to be detected has a second predetermined property, and for each of the plurality of candidate light blobs, determining whether to discard the candidate light blob from the plurality of candidate light blobs based on a second property of the candidate light blob in saliency mask with respect to the second predetermined property.

7. The method according to claim 1, wherein identifying a plurality of candidate regions comprises:
for each of the plurality of candidate light blobs, locating a corresponding light blob in the bright frame based on a position of the candidate light blob from the dark frame, and identifying a corresponding candidate region in the bright frame based on a position of the located corresponding light blob in the bright frame.

8. The method according to claim 1, wherein each of the plurality of candidate light blobs is classified using a classifier trained with respect to a plurality of predetermined types of classes, and classifying each of the plurality of candidate light blobs comprises:
processing the candidate region corresponding to the candidate light blob to classify the candidate region under one of the plurality of predetermined types of classes; and
labeling the candidate light blob with a class label corresponding to the one of the plurality of predetermined types of classes which the corresponding candidate region is classified under,
wherein whether one or more of the plurality of classified candidate light blobs is a signal light from the particular type of signaling device is evaluated based on the respective class labels associated with the one or more classified candidate light blobs.

9. The method according to claim 1, further comprises:
tracking at least one of the classified candidate light blobs evaluated to be said signal light for a series of bright frames to obtain a trajectory associated with the classified candidate light blob; and
verifying whether the at least one of the classified candidate light blobs evaluated to be the signal light is said signal light based on one or more characteristics of the trajectory associated thereto.

10. The method according to claim 5, wherein the particular type of signaling device is a traffic light, and the plurality of predetermined types of colours comprises green, amber, and red.

11. A signal light detection device, comprising:
a frame module configured to obtain a dark frame and a bright frame of an environment, the dark frame and the bright frame each comprising a plurality of light blobs corresponding to lights captured in the environment;
a candidate light blob identification module configured to identify a plurality of candidate light blobs from the plurality of light blobs in the dark frame;
a candidate region identification module configured to identify a plurality of candidate regions in the bright frame based on the plurality of candidate light blobs identified from the dark frame;
a classifier module configured to classify each of the plurality of candidate light blobs based on the corresponding candidate region from the bright frame; and
a signal light evaluation module configured to evaluate whether one or more of the plurality of classified candidate light blobs is a signal light from a particular type of signaling device.

12. The signal light detection device according to claim 11, wherein the signal light to be detected has a first predetermined property, and wherein the candidate light blob identification module is further configured to:
generate a saliency map based on the dark frame with respect to the first predetermined property; and
for each pixel of the saliency map that has a saliency score above a predetermined threshold, label the pixel with a property label related to the first predetermined property.

13. The signal light detection device according to claim 12, wherein the saliency score is an overall saliency score determined for each of a plurality of pixels of the dark frame with respect to a plurality of predetermined types of the first predetermined property, and
the candidate light blob identification module is further configured to:
determine, for each pixel of the saliency map that has an overall saliency score above the predetermined threshold, individual saliency scores for the pixel with respect to the plurality of predetermined types of the first predetermined property, respectively, and
label the pixel with a property label corresponding to one of the plurality of predetermined types of the first predetermined property.

14. The signal light detection device according to claim 13, wherein the overall saliency score is determined based on a plurality of histograms related to the plurality of predetermined types of the first predetermined property, respectively.

15. The signal light detection device according to claim 12, wherein the candidate light blob identification module is further configured to:
apply a predetermined threshold to the saliency map to obtain a saliency mask;
identify a plurality of groups of neighbouring pixels in the saliency mask as the plurality of candidate light blobs, respectively, each group of neighbouring pixels having common property labels; and
wherein the signal light to be detected has a second predetermined property, and for each of the plurality of candidate light blobs, determine whether to discard the candidate light blob from the plurality of candidate light blobs based on a second property of the candidate light blob in the saliency mask with respect to the second predetermined property.

16. The signal light detection device according to claim 11, wherein the candidate region identification module is further configured to:
for each of the plurality of candidate light blobs, locate a corresponding light blob in the bright frame based on a position of the candidate light blob from the dark frame, and identify a corresponding candidate region in the bright frame based on a position of the located corresponding light blob in the bright frame.

17. The signal light detection device according to claim 11, wherein the classifier module is trained with respect to a plurality of predetermined types of classes, and the classifier module is further configured to:
process the candidate region corresponding to the candidate light blob to classify the candidate region under one of the plurality of predetermined types of classes; and
label the candidate light blob with a class label corresponding to the one of the plurality of predetermined types of classes which the corresponding candidate region is classified under,
wherein the signal light evaluation module is configured to evaluate whether one or more of the plurality of classified candidate light blobs is a signal light from the particular type of signaling device based on the respective class labels associated with the one or more classified candidate light blobs.

18. The signal light detection device according to claim 1, further comprising a tracking module configured to:
track at least one of the classified candidate light blobs evaluated to be said signal light for a series of bright frames to obtain a trajectory associated to the classified candidate light blob; and
verify whether the at least one of the classified candidate light blobs evaluated to be the signal light is said signal light based on one or more characteristics of the trajectory associated thereto.

19. The signal light detection device according to claim 13, wherein the first predetermined property is a colour of the signal light, the particular type of signaling device is a traffic light, and the plurality of predetermined types of colour comprises green, amber, and red.

20. A computer program product, embodied in one or more computer-readable storage mediums, comprising instructions executable by one or more computer processors to perform a method of signal light detection, the method comprising:
obtaining a dark frame of an environment, the dark frame comprising a plurality of light blobs corresponding to lights captured in the environment;
obtaining a bright frame of the environment, the bright frame comprising a plurality of light blobs corresponding to lights captured in the environment;
identifying a plurality of candidate light blobs from the plurality of light blobs in the dark frame;
identifying a plurality of candidate regions in the bright frame based on the plurality of candidate light blobs identified from the dark frame;
classifying each of the plurality of candidate light blobs based on the corresponding candidate region from the bright frame; and
evaluating whether one or more of the plurality of classified candidate light blobs is a signal light from a particular type of signaling device.
